(19) United States
(12) Patent Application Publication
(10) Pub. No.: US 2010/0204807 A1
(43) Pub. Date: Aug. 12, 2010

(54) Crowd optimization of ambient conditions

(75) Inventor: Scott Alan Isaacson, Woodland Hills, UT (US)

Correspondence Address: KING & SCHICKLI, PLLC, 247 NORTH BROADWAY, LEXINGTON, KY, 40507, US

(73) Assignee: Novell, Inc.

(21) Appl. No.: 12/322,902

(22) Filed: Feb. 9, 2009

(51) Int. Cl. G05B 13/02; G06N 5/02; G06F 17/00

(52) U.S. Cl. 700/28; 700/49; 700/47; 700/90

(57) ABSTRACT

Methods and apparatus optimize ambient conditions of a physical location based upon input from multiple users (e.g., a “crowd) to avoid dominance by only one or a few users. Representatively, a plurality of input devices are distributed throughout the location and users, at certain times, or upon querying, enter their ambient condition preferences. Then, per the particular locations of the input devices, ambient conditions, such as lighting, temperature, sound, air flow, etc., are adjusted based on the inputs. In this manner, anyone can be in a room, at any time, and have their input considered as part of setting the room conditions. No longer does one or a few parties dominate control and no pre-programmed preferences are required. Controllers, input devices, systems, and computer program products, to name a few, are also contemplated.

### FIELD OF THE INVENTION

Generally, the present invention relates to controlling, setting, adjusting, monitoring, etc., ambient conditions of a physical environment. Particularly, although not exclusively, it relates to optimizing ambient conditions, such as lighting, temperature, sound, air flow, etc., based on input from more than one person, e.g., a “crowd.” In certain embodiments, optimization is dynamic, (near) real time and interactive, to name a few.

### BACKGROUND OF THE INVENTION

Adjusting ambient conditions of a physical location has always been of interest to people. For a variety of reasons, people control their environments by making them warmer/colder, lighter/darker, nosier/quieter, etc. Intuitively, people adjust their environment according to preference, with the caveat that modern adjustments fit within a financially acceptable range. That is, people adjust temperature to make themselves comfortable, but will sometimes keep their homes in the winter somewhat cooler than desired to keep their electricity bill at a reasonable level. Similarly, a warehouse may dim overhead lights to lower energy overhead.

With the advance of computers, it is even known to automatically control ambient conditions of a location, such as a house, building or corporation. For example, modern home thermostats are regularly (automatically) time-adjusted to lower heating temperatures at night when people sleep and then increase them in the morning when people arise. Similarly, timers are prevalent in corporate settings to automatically dim or turn-off lights after the conclusion of business hours. Further still, many modern buildings have central control rooms that not only monitor, set, adjust or otherwise control ambient conditions of local room(s) of the building, but they also coordinate the activities of many such locations throughout the building. They are even known to provide feedback to people by way of electronic displays or other communication devices so that users are made aware of current conditions. More complex designs even contemplate control under less interactive conditions, such as setting water pressure, elevator call operation, zone-control, or the like, and many include alarms or other control measures.

In still other designs, recent advancements in sensors, algorithms, techniques, etc., have made it possible to determine whether humans are in a room and then automatically adjust ambient conditions according to known presets. For example, certain prior art techniques involve detection of a human in a room by way of a motion detector or a carried RFID card. In turn, room settings, such as lighting, temperature, sound, etc., are adjusted by way of a central controller according to preferences of the user earlier pre-programmed into the controller, especially according to different times of the day, seasons of the year, or the like.

Regardless of situation, individual users are still generally allowed to override present settings by making unique adjustments to the ambient conditions according to selfish whims. For instance, users can adjust a set thermostat to a more preferable temperature, open a window, dim or increase lighting, close or open doors, etc. Problematically, however, a single user's self interest may not always coincide with the interest of others in the room. That is, one person in a stuffy room may go over and open a window in winter, while another person may be cold and, not only want the window shut, but want to increase the thermostat temperature to a higher setting. While usually small groups of people can compromise on the settings of ambient conditions in local proximity, large numbers of people in close or even remote proximity, such as are regularly found on an assembly-line, in an office, at a movie theater/concert/restaurant, etc., often avoid compromise.

The reasons for lack of compromise are many, but sometimes relate to: people feeling too embarrassed to express their true opinion (e.g., “everyone else must think it is too hot in here since that person opened the window, but I am freezing”); people feeling their opinion of the ambient conditions is not heard or valued (e.g., “only the obnoxious or boisterous ones that demand their own way are ever heard”); people feeling powerless since their boss or manager is the person changing the ambient conditions to meet their own personal preferences, (e.g., “it is too political to be heard”); etc. Also, there is no present way to tell a master control center, even in the most sophisticated of buildings, that everyone is hot even though the system controller seems to indicate that the temperature is appropriate. Further, ambient conditions are all too often set with too few sample points, e.g., a single user's personal preference, and sometimes with course-grained control, e.g., binary (light on/light off).

Accordingly, a need exists in the art of setting, controlling, adjusting, etc., ambient conditions to optimize them, especially for “crowds” of persons each with their own preferences. The need further extends to allowing all people in the crowd to decide as a collective group about when and by how much to change ambient conditions, even if it means overriding set control points. In this manner, ambient conditions can be finely controlled with more data points than previously allowed, conditions can actually meet the desires of the crowd, and satisfaction can be yielded whereby individuals know their desires have been considered and considered anonymously without having to share that information with others of the crowd. Further still, financial constraints of the prior art regarding energy costs should remain a constraint, even when optimizing ambient conditions for a crowd. Naturally, any improvements along such lines should further contemplate good engineering practices, such as ease of implementation, unobtrusiveness, simplistic coordination with other ambient-condition devices, e.g., lights, HVAC, water, motors, etc.

### SUMMARY OF THE INVENTION

The above-mentioned and other problems become solved by applying the principles and teachings associated with the hereinafter-described crowd optimization of ambient conditions. At a high level, methods and apparatus optimize ambient conditions of a physical location based upon input from more than one user. Representatively, a plurality of input devices are distributed throughout the physical location and users, at certain times, upon querying, etc., enter their ambient condition preferences. Then, per the particular locations of the input devices, ambient conditions, such as lighting, temperature, sound, air flow, etc., are adjusted based on the inputs. In this manner, anyone can be in a room, at any time, and have their input considered as part of setting/adjusting room conditions. No longer does one or a few parties dominate control and no pre-programmed preferences of the users are required. Also, a variety of pre-established rules may be utilized to ensure compliance with overhead attributable to energy costs, to resolve conflicts or ties between party inputs, to average inputs or assign weights, or to control conditions by zones, to name a few.

In a computing system embodiment, a controller is configured to receive multiple selections from the plurality of users regarding their preferences of the ambient conditions. It is also configured to (in)directly send signal(s) to light(s), HVAC unit(s), motor(s), fan(s), etc., to adjust in (near) real time a lighting level, a temperature, a sound, an air flow, etc. Also, the controller is configured to receive the multiple selections in such a way that no foreknowledge is needed of the ambient condition preferences of the users and any user, at any time, can make input selections.

Representative input devices include a variety of controls, displays, UI's, input means, etc. Similarly, computer program products contemplate installation of executable instructions on a controller to optimize ambient conditions based upon user inputs entered on the input devices distributed at various places throughout the physical location. The executable instructions further enable configuration of the controller to recognize multiple selections from the plurality of users regarding their preferences. The computer program products may also exist as downloads from upstream computing devices or on a computer readable medium. The computer program products are also available for installation on a network appliance or individual computing devices.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative physical location in which crowd inputs are used to optimize its ambient conditions;

FIG. 2 is a diagrammatic view in accordance with the present invention of a representative input device for users to indicate selections of ambient conditions; and

FIG. 3 is a high-level flow chart in accordance with the present invention for optimizing ambient conditions of a physical location based on inputs of a crowd.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus are hereinafter described for optimizing ambient conditions according to collective selections of a crowd.

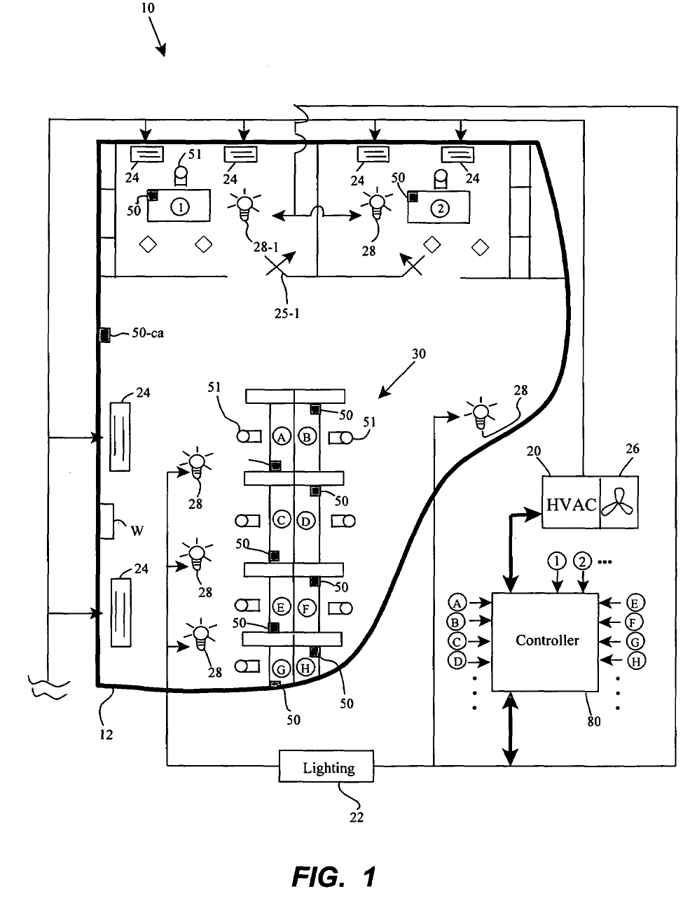

With reference to FIG. 1, a representative environment 10 includes a physical location 12 in need of having ambient conditions crowd optimized, in this instance the planar view of an office layout. Of course, the physical location could be any of a variety of locations, such as a stationary structure like a house, room, entire building, movie theater, lecture hall, restaurant, etc., a mobile structure like a car, bus, airplane, train, boat, etc., combinations thereof or even other locations that are readily imagined by those of skill in the art. In discussing “ambient conditions,” they are any of a variety of surrounding atmospheres and include, but are not limited to, lighting, heating/cooling, sounds, air quality/flow, brightness, smells, etc., and optimizing them contemplates monitoring, setting, adjusting, controlling, etc., the conditions to keep them as-is, or making them lighter/darker, warmer/colder, nosier/quieter, cleaner/dirtier, etc. Representatively, a heating, ventilation and air-conditioning system (HVAC) 20 and a lighting system 22 will be used to describe the ambient conditions, including their optimization in the physical location 12 by way of heat/air-conditioning registers 24, a fan or motor unit 26 and lights 28.

Also, various control zones in the environment are illustrated, and mostly these differentiate themselves from one another as to the relative effect that one zone has on another, per ambient condition(s). For instance, consider the scenario of closed-door offices 1, 2 and cubicle desks A-H. If closed-door office 1, has its light 28-1 turned on, but its door 25-1 is closed, and has no windows, then little if any lighting effect will be noticed in the cubicle section 30. On the other hand, if closed-door office 1 has its door 25-1 open, and a room temperature is set at 78° F. in the summertime on a hot day, it will likely have a temperature effect in the cubicle section 30, especially nearest cubicle desks A and B. Thus, control zones can be established by the effect they have on other zones, and such may be an effect for one or more ambient conditions, e.g., temperature, but not necessarily another ambient condition, e.g., lighting. Naturally, control zones can also be established by physical proximity as well. That is, all of the planar view in location 12 may be one collective zone, but another floor in a same building (not shown) could be still another collective zone. Or course, skilled artisans can envision other scenarios.

With the foregoing environment as backdrop, consider further a plurality of input devices 50 distributed variously throughout the physical location 12. In this manner, users 51 can conveniently enter selections into the devices to indicate their preferred preferences for the relevant ambient conditions. The devices can be provided in a variety of positions, such as associated with office desks, as seen. Alternatively, they may be located at other positions, such as in a common area 50-ca, on the floor, wall, integrated within a chair, such as in a chair arm, etc. They could even be distributed with persons for situations as the user moves about from location to location, such as on a corporate ID badge, a remote control, or even on traditional devices like walkie-talkies, cell phones or PDA's that have relevant applications installed or downloaded to them. Alternatively still, the input devices could be server-based web pages that are accessed by users via intranet, internet or other browser tools. In any situation, the devices 50 can also be of the wired (e.g., handheld device with power and transmission via a wired connection using serial or parallel, analog or digital communications protocols, etc.), or wireless variety (using RFID or IR or Cellular or similar).

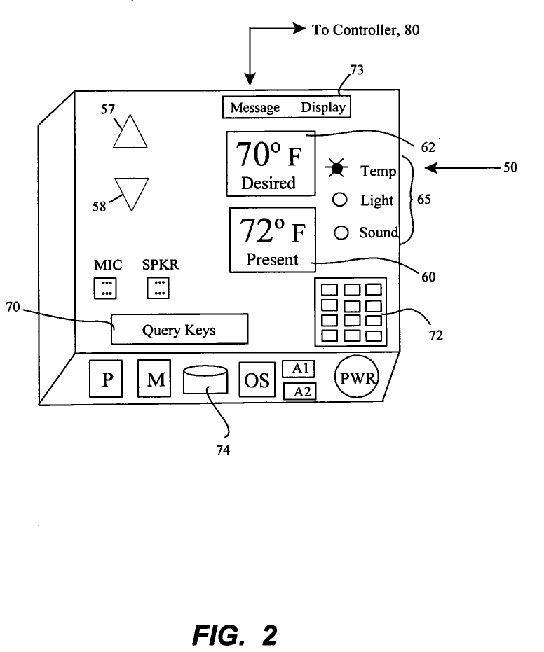

As seen in FIG. 2, a representative input device 50 includes a variety of ambient control input mechanisms. Representatively, these include up/down buttons or switches 57, 58 to indicate preference to change a present setting 60 to a desired setting 62. Further, it includes buttons 65 to indicate what type of ambient conditions are desired to be changed. Further still, it representatively includes keypads 70 or programmable softkeys 72 like in a PDA or cellphone. It may also include a display 73 for visually communicating with a user of the device, as well a microphone (mic) and speaker (spkr) for aurally communicating with them. (The messaging display might also have some minimal feedback indicator, such as “it is as cold as we can make it,” even when users press their “make it colder” button.) It will also likely have a processor, P, memory, M, and disk storage 74, for computing and saving computing calculations, storing and executing installed instructions, etc., as is typical, as well as an operating system (OS), and one or more applications A1, A2, as are further typical with modern handheld computing devices. In addition, each device 50 could have a location value either hardcoded for fixed devices or manually specified for less intelligent wireless devices or could even be integrated with GPS for automatic specification of location. In this manner, selections on the input devices can be made known to a controller 80 (FIG. 1) regarding the relative whereabouts of the user making the selection to ambient conditions.

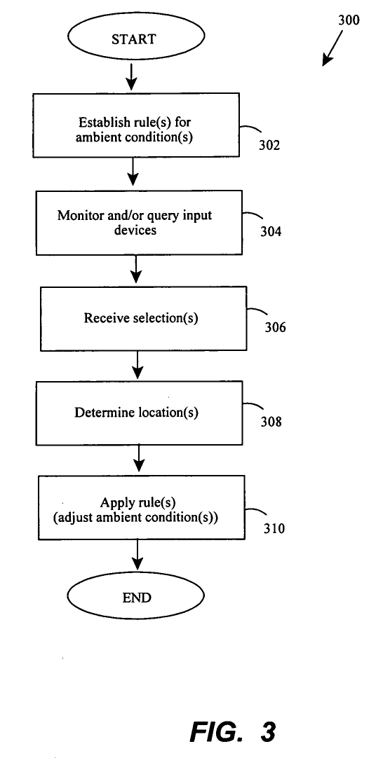

With reference to FIG. 3, the use of the input device in the physical location to crowd-optimize present ambient conditions is given generally as 300. Initially, at step 302, a rule is established that sets forth treatment of the ambient conditions. For example, rules can set forth whether ambient conditions will be changed, or not, relative to financial considerations of energy costs. Other rules might contemplate resolving ties or conflicts between inputs. Still others might contemplate weighting inputs or averaging them. The rules can also be programmed with either fixed rules or dynamic rules, or combinations, on how to react to the input data. They can even be intelligently learned, such as with artificial intelligence or other routines. In any situation, the rules are preferably carried out by the operation of the controller 80, FIG. 1 and its relationship to actual devices such as the HVAC and lighting systems 20, 22.

Representatively, the first scenario may appreciate that all user inputs indicate making a room colder than 74° F. on a hot summer day, but that doing so will increase the relevant energy bill of the physical location by hundreds of dollars per one degree of lower temperature change. In turn, the set temperature may be kept at 74° F. despite the user selections.

In the second scenario, if the controller sees that there are 100 input devices in a physical location and 50 suggest “hotter” and 50 suggest “colder,” it might not do anything. However, if all 100 suggest “hotter by a little” the controller might send a signal to the HVAC to change the temperature control to make the environment just a little warmer. If, on the other hand, all 100 suggest “colder by a lot” then the centralized system might change the temperature control to make the environment much colder. Similarly, if half the inputs in the cubicle region (e.g, A, C, E, G) say colder and the other half (e.g., B, D, F, H) are neutral, then the controller could make the physical location colder only in the portion of the cubicle region closest to the windows W, FIG. 1 (e.g., zone control).

In the third scenario, all of the collective inputs may be analyzed and averaged together to determine that the temperature should be a certain degree. To weight them, input devices in the cubicle region 30 of FIG. 1 might be given preferential treatment over the closed-door offices 1 and 2, FIG. 1, since many more people exist in the cubicle region than in the closed-door offices.

Of course, skilled artisans can contemplate other situations for each of the foregoing and still other scenarios.

Once the rules are set, or a framework established for treatment of the user selections on the input devices, step 302, the pluralities of input devices 50 are monitored by the controller for user selections. Alternatively, users are queried by the controller to make a selection regarding one or more specific ambient conditions. In the former, monitoring can occur at specific times of the day, such as at the beginning of work shifts, periodically, such as every two minutes, four hours, etc., depending upon how many data points the rules require, or monitoring can be at random or other times. In the latter, a controller might signal users of the input devices visually via the messaging display 73, or aurally via the speaker. Still other queries might come “through the grapevine” from management, via a web page, or on unrelated communication devices. Of course, other scenarios are readily imagined.

Eventually, per either the monitoring or querying scenario, the user selections of one or more specific ambient conditions are received, step 306. That is, a user may indicate a request to change temperature to a hotter setting, such as by selecting the up button 57, FIG. 2, while the “Temp” ambient condition 65 is selected. In turn, the input device could be set up to either take a binary value (e.g., “hotter/colder”) or a relative value (hotter by +1 or +2 or +10). Alternatively, the user could enter selections by typing 70° F. into the desired setting 62. Alternatively still, input devices might be able to accept binary values with more frequency as stronger suggestions, such as when a user pushes the elevator button over and over more frequently thinking that it might make the elevator car come more quickly.

At step 308, once the user selections have been received, they are correlated to the actual local places of the input devices and then the rule of step 302 is applied to actually adjust ambient conditions, step 310. In a broad sense, this means that an ambient condition is changed from a first setting to a second setting. More particularly, this might consist (as before) of adjusting the temperature of the cubicle region 30, FIG. 1 to a colder temperature setting if half the inputs in the cubicle region (e.g, A, C, E, G) provide inputs of “colder” (or actual temperature number are entered that are lower than the present temperature setting), while the other half of the inputs (e.g., B, D, F, H) are neutral. Similarly, this might consist of receiving 100 inputs of actual temperature entries and averaging them to arrive at one temperature setting, and then setting the HVAC unit to produce this temperature. Naturally, many more possibilities are imagined by skilled artisans.

Also, as can be appreciated in the following simple example, the foregoing resolves a scenario like opening/closing windows in a small office. If, for instance, there are five people in the office and four desire an open window, but one desires a closed window, then the controller would send appropriate signals to open the window. While not all persons got their desired result, some measure of satisfaction is garnered since all parties know their input was received and considered. Their input was also considered anonymously, without the attendant problems described in the background section regarding office politics, personal embarrassment, or the like. Ultimately, it also avoids situations of dominance of ambient conditions by less than substantially all the users, i.e., if the sole person wanting the open window was a manager of the other four persons, the manager's potential dominance was out-voted by the other persons.

Going forward, skilled artisans can now imagine a situation in which a speaker in a lecture hall requests the audience to “please adjust the lights” and everyone starts to make suggestions on their input devices until a certain pre-established rule is reached, such as the maximum number of people in the audience have been “satisfied.” Similarly, as controls become more ubiquitous, there is less need to prompt users for inputs since people would know to interact with their experience and perception of the environment and provide their immediate feedback and suggestions on how to improve it.

Appreciating that implementation of the foregoing can occur in part with humans as well as computing devices, skilled artisans will understand that crowd-optimization of ambient conditions may be managed by people, such as system administrators, as well as executable code, or combinations of each. As such, methods and apparatus of the invention further contemplate computer executable instructions, e.g., code, software, or controller firmware, as part of computer program products on readable media, e.g., disks for insertion in a drive of computing device, or available as downloads or direct use from an upstream computing device. When described in the context of such computer program products, it is denoted that items thereof, such as modules, routines, programs, objects, components, data structures, etc., perform particular tasks or implement particular abstract data types within various structures of the computing system which cause a certain function or group of function, and such are well known in the art.

Certain advantages of the invention over the prior art should now be readily apparent. For example, anyone can be in a room, at any time, and have their input considered as part of setting/adjusting the room conditions. No longer does one or a few parties dominate control and no foreknowledge of ambient condition preferences or pre-programmed preferences of users are required. Also, this allows all people in a group to decide as a whole group about when and by how much to change ambient conditions. Further still, certain objectives are achieved, such as: allowing all or substantially all people in a group the satisfaction that their desire to change an ambient condition has been considered without having to share that information with the rest of the group; allowing optimized settings of ambient conditions for groups based on more data points than previously allowed and with finer control than previously allowed; allowing for a centralized system to determine if there are localized problems with ambient conditions and change the settings that would improve the conditions only in that localized or zone area; only changing settings of ambient conditions when there is input that suggests it needs to be changed rather than by setting fixed rules that are blind to optimizations; and remaining cognizant of financial constraints associated with energy and other overhead costs, to name a few.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures or expanding the system to replicate the embodiments multiple times.

1. A method of optimizing ambient conditions of a physical location based upon input entered from a plurality of users in the physical location on a plurality of input devices distributed at various places throughout the physical location, comprising:
without foreknowledge of ambient condition preferences of the users, receiving selections from the users via the plurality of input devices; and
adjusting one or more of the ambient conditions from a first setting to a second setting according to substantially all the received selections.

2. The method of claim 1, further including distributing the plurality of input devices throughout the physical location.

3. The method of claim 1, wherein the adjusting one or more of the ambient conditions further includes adjusting the ambient conditions according to determined local positions of the input devices.

4. The method of claim 1, wherein the receiving selections occurs at specific times, randomly or upon querying.

5. The method of claim 1, wherein the adjusting the ambient conditions only occurs for a portion of the physical location but not another portion of the physical location.

6. The method of claim 1, wherein the adjusting the ambient conditions further includes evaluating compliance of the received selections against a pre-established rule.

7. A method of optimizing ambient conditions of a physical location based upon input from a plurality of users in the physical location, comprising:
distributing a plurality of input devices throughout various places of the physical location;
without foreknowledge of ambient condition preferences of the users, receiving selections from the users via the plurality of input devices; and
adjusting the ambient conditions from a first setting to a second setting according to all or substantially all the received selections thereby avoiding dominance of ambient conditions by less than said substantially all the users.

8. The method of claim 7, further including establishing a policy for said adjusting the ambient conditions as a function of the received selections.

9. The method of claim 7, further including monitoring or querying the plurality of input devices for user indication of a specific ambient condition.

10. The method of claim 7, further including determining a local position of each of the plurality of input devices as they are said distributed in said physical location.

11. The method of claim 10, wherein said adjusting the ambient conditions further includes adjusting the ambient conditions according to said determined local positions.

12. A computer program product having executable instructions for undertaking the receiving and adjusting steps of claim 7.

13. A method of optimizing ambient conditions of a physical location based upon input from a plurality of users in the physical location, comprising:
distributing a plurality of input devices throughout various places of the physical location;
monitoring or querying for user indication on the input devices of a specific ambient condition;
without foreknowledge of ambient condition preferences of the users, receiving selections from the users via the plurality of input devices;
determining the actual places of the distributed input devices; and
in accordance with the determined actual places, adjusting the ambient conditions from a first setting to a second setting according to all or substantially all the received selections thereby avoiding dominance of ambient conditions by less than said substantially all the users.

14. A method of optimizing ambient conditions of a physical location based upon input entered from a plurality of users in the physical location on a plurality of input devices distributed at various places in the physical location, comprising;
programming a controller to receive selections from the users via the plurality of input devices; and
without foreknowledge of ambient condition preferences of the users, adjusting at least one ambient condition of the physical location according to all or substantially all the received selections thereby avoiding dominance of ambient conditions by less than said substantially all the users.

15. A computing system for optimizing ambient conditions of a physical location based upon input entered from a plurality of users in the physical location on a plurality of input devices distributed at various places throughout the physical location, comprising a controller configured to receive multiple selections from the plurality of users regarding their preferences of the ambient conditions, the controller configured to said receive multiple selections without foreknowledge of ambient condition preferences of the users and via the plurality of input devices to thereafter send a signal to a light, an HVAC unit, a motor or fan to adjust from a first setting to a second setting one of a lighting level, a temperature, a sound, and an air flow in the physical location.

16. The computing system of claim 15, wherein the input devices include means for said entering inputs.

17. The computing system of claim 15, wherein the controller is further configured to query the users for said entering inputs.

18. The computing system of claim 15, wherein the controller is further configured to determine actual local positions in the physical location of the input devices having had inputs entered.

19. A computer program product for installing on a controller to optimize ambient conditions of a physical location based upon inputs entered from a plurality of users in the physical location on a plurality of input devices distributed at various places throughout the physical location, the computer program product having executable instructions to configure the controller to recognize multiple selections from the plurality of users regarding their preferences of the ambient conditions without foreknowledge of ambient condition preferences of the users.

20. The computer program product of claim 19, further including executable instructions to configure the controller to directly or indirectly send a signal to a light, an HVAC unit, or a motor to adjust from a first setting to a second setting one of a lighting level, a temperature, and a sound, respectively, in the physical location.
